(19) United States
(12) Patent Application Publication
(10) Pub. No.: US 2016/0347170 A1
(43) Pub. Date: Dec. 1, 2016

(54) Integrated Wheel and Planet Carrier

(71) Applicant: Caterpillar Inc., Peoria, IL (US)

(72) Inventors: Jeffrey Edward Jensen, Dunlap, IL (US); Jacob C. Wyss, Eureka, IL (US)

(73) Assignee: Caterpillar Inc., Peoria, IL (US)

(21) Appl. No.: 14/723,732

(22) Filed: May 28, 2015

(51) Int. Cl. B60K 17/04; F16H 1/28

(52) U.S. Cl. CPC B60K 17/046; F16H 1/28

(57) ABSTRACT

A wheel assembly for a machine is disclosed. The wheel assembly may include a hub coupled to an axle housing, and a planetary gear set. The planetary gear set may include a single-piece integrated wheel and planet carrier. The single-piece integrated wheel and planet carrier may serve a wheel of the machine, and may be rotatably mounted within the hub by a first bearing set and a second bearing set axially spaced apart from the first bearing set.

### FIELD OF THE DISCLOSURE

The present disclosure relates generally to machines and, more particularly, to a wheel assembly for a machine.

### BACKGROUND OF THE DISCLOSURE

Machines, such as earthmoving and construction machines, generally include at least one pair of wheels that are driven by a drive assembly. The drive assembly generally includes a power source supplying power to an axle shaft, which is attached to a planetary gear set. The planetary gear set may provide a controlled application of power from the axle shaft to the wheels.

In addition, each wheel is typically mounted on a rotating wheel hub and stationary spindle circumscribing the axle shaft. The wheel hub may connect a stationary ring gear of the planetary gear set to the spindle, and the spindle may be coupled to an axle housing. In this way, a reaction torque from the ring gear passes through the wheel hub to the spindle and finally to the axle housing, which may constitute a long path for the reaction torque and cause considerable stress on those components. Moreover, with many parts and various spatial relationships among such parts, a wheel assembly can result in an expensive and sizeable structure.

Furthermore, a rim and a tire are attached to each wheel with a load of the machine being transferred down through the tires. Typically, however, the ring gear, planet gears, and sun gear of the planetary gear set are cantilevered with respect to a centerline of the tire. During operation, this may result in the reaction torque through the planet gears and the load on the tires being imbalanced.

As a result, the planetary gear set may experience cantilever effects from the non-uniform loading. In addition, the imbalance may affect a life of the bearings that support the wheel on the wheel hub and spindle. Accordingly, there is a need for a wheel design that is more balanced, as well as, cost-effective and compact.

A wheel structure is disclosed in U.S. Pat. No. 2,424,578, entitled, “Wheel and Axle Unit.” The '578 patent describes a rotating wheel hub having a substantially cylindrical formation. The periphery of the wheel hub carries the supporting rim for a tire, and an outer end of the wheel hub is attached to a pinion carrier that supports pinions of a planetary gear set. In the '578 patent, an inner plate is attached to an inner end of the wheel hub by bolts Inner bearings are provided between the inner plate and a stationary axle member that circumscribes the shaft, while outer bearings are provided between the pinion carrier and the stationary axle member. The wheel hub of the '578 circumscribes the axle member, and the inner and outer bearings rotatively mount the wheel hub on the axle member. While effective, improvements are still desired to provide a more balanced, cost-effective, and compact wheel assembly.

### SUMMARY OF THE DISCLOSURE

In accordance with one embodiment, a wheel assembly for a machine is disclosed. The wheel assembly may include a hub coupled to an axle housing, and a planetary gear set. The planetary gear set may include a single-piece integrated wheel and planet carrier. The single-piece integrated wheel and planet carrier may serve a wheel of the machine, and may be rotatably mounted within the hub by a first bearing set and a second bearing set axially spaced apart from the first bearing set.

In accordance with another embodiment, a machine is disclosed. The machine may include a power source, an axle shaft operatively coupled to the power source, an axle housing enclosing at least part of the axle shaft, a hub coupled to the axle housing, and a planetary gear set operatively mounted to the axle shaft. The planetary gear set may include a ring gear rigidly fixed to the hub, a plurality of planet gears in meshing contact with the ring gear, and a planet carrier operatively connecting the plurality of planet gears. The planet carrier may serve as a wheel. The machine may further include a first bearing set and a second bearing set axially spaced apart from the first bearing set. Each of the first bearing set and the second bearing set may rotatably mount the planet carrier within the hub.

In accordance with yet another embodiment, a wheel assembly for a machine is disclosed. The wheel assembly may include a first bearing set, a second bearing set spaced apart from the first bearing set, and a plurality of planet gears centered between the first bearing set and the second bearing set in order to balance a load of the machine.

These and other aspects and features will become more readily apparent upon reading the following detailed description when taken in conjunction with the accompanying drawings. In addition, although various features are disclosed in relation to specific exemplary embodiments, it is understood that the various features may be combined with each other, or used alone, with any of the various exemplary embodiments without departing from the scope of the disclosure.

### BRIEF DESCRIPTION OF THE DRAWINGS

FIG. 1 is a perspective view of a machine, in accordance with one embodiment of the present disclosure;

FIG. 2 is a cross-sectional view of a wheel assembly for the machine of FIG. 1;

FIG. 3 is a cutaway perspective view of the wheel assembly of FIG. 2;

FIG. 4 is a cutaway perspective view of the wheel assembly of FIG. 2 with a rim assembly attached; and

FIG. 5 is a diagram illustrating power flow through the wheel assembly of FIG. 2 during operation.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof.

### DETAILED DESCRIPTION

The present disclosure provides, among other things, a wheel assembly for a machine that includes a single-piece integrated wheel and planet carrier. In addition, the disclosed wheel assembly has a hub that takes the place of and eliminates the need for a spindle. A ring gear of the disclosed wheel assembly is also splined into the hub.

Thus, compared to prior art wheel designs, the disclosed wheel assembly, and machine having such a wheel assembly, has a reduced number of main components. This results in a shortened overall axle length, a drastically decreased cost of manufacturing, as well as significantly reduced weight and space requirements. Furthermore, the disclosed wheel assembly centers a planetary gear set with a centerline of a tire, thereby providing a more balanced, vertical load of the machine on the planetary gear set and bearings of the wheel assembly. In so doing, the present disclosure provides a balanced, cost-effective, and compact wheel assembly for machines.

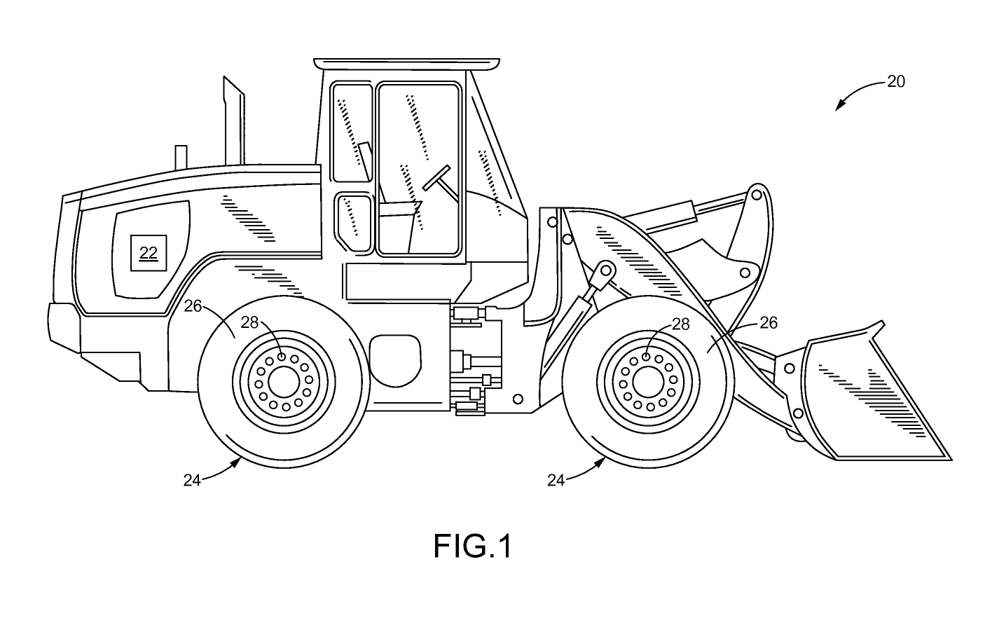

Referring now to the drawings, and with specific reference to FIG. 1, a machine consistent with certain embodiments of the present disclosure is generally referred to by reference numeral 20. Generally, corresponding reference numbers will be used throughout the drawings to refer to the same or corresponding parts. It is to be understood that although the machine 20 is illustrated as a wheel loader, the machine 20 may be of many other types. As used herein, the term “machine” refers to a mobile machine that performs a driven operation involving physical movement associated with a particular industry, such as, earthmoving, construction, landscaping, forestry, transportation, agriculture, mining, etc.

Non-limiting examples of machines include commercial and industrial machines, such as, earth-moving vehicles, loaders, dozers, motor graders, tractors, backhoes, excavators, trucks, mining vehicles, on-highway vehicles, trains, agricultural equipment, material handling equipment, and other types of machines that operate in a work environment. It is to be understood that the machine 20 is shown primarily for illustrative purposes to assist in disclosing features of various embodiments, and that FIG. 1 does not depict all of the components of a machine.

The machine 20 may include an engine 22, or other power source, operatively configured to drive wheel assemblies 24. Wheel assemblies 24 may be configured to move the machine 20 along the ground. Each wheel assembly 24 may include a tire 26 mounted to a rim 28. The tire 26 may provide traction between the machine 20 and the ground. Although wheel assemblies 24 are shown as wheels, in FIG. 1, other types of traction devices may be used. Furthermore, the machine 20 may include four wheel assemblies 24, two left wheel assemblies and two right wheel assemblies. However, any number of wheel assemblies 24 may be used.

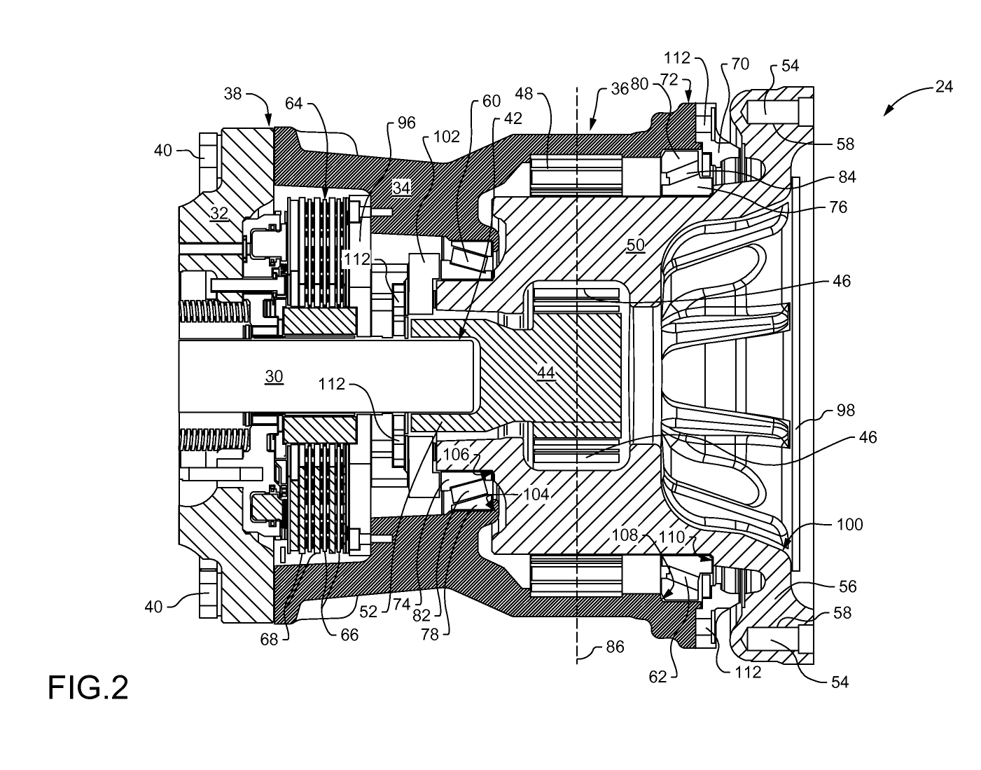

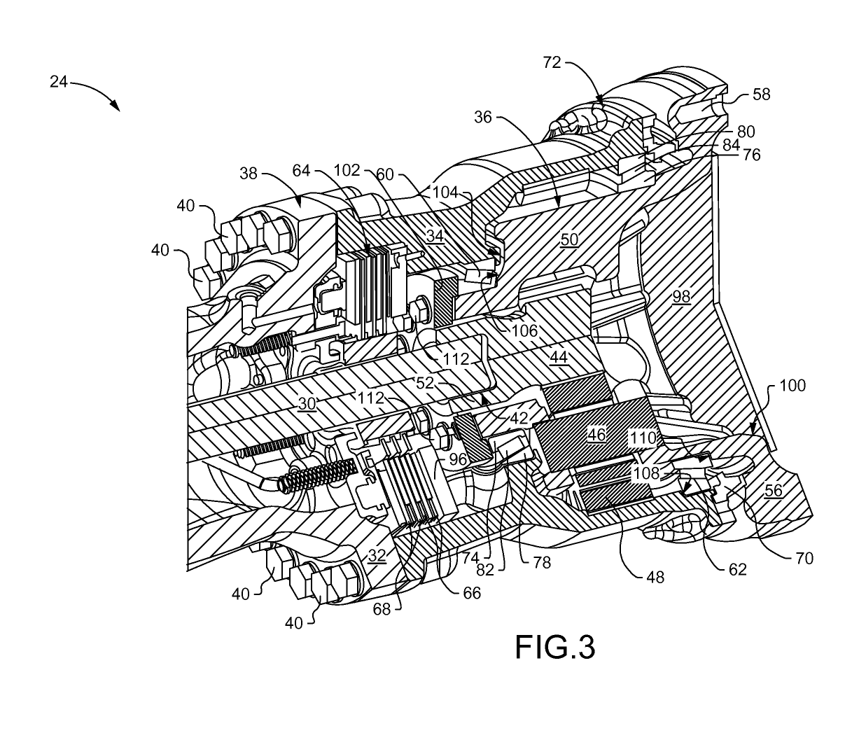

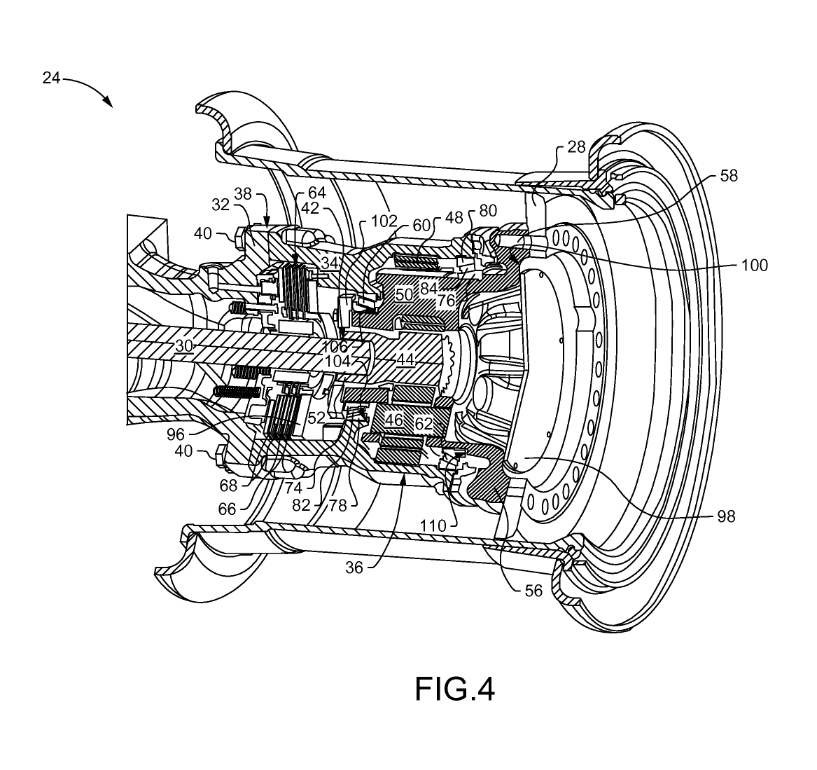

As shown in FIGS. 2-4, with continued reference to FIG. 1, each wheel assembly 24 may further include an axle shaft 30, an axle housing 32, a hub 34, and a planetary gear set 36, in accordance with an embodiment of the present disclosure. The axle shaft 30 may be operatively connected to and driven by the engine 22 (FIG. 1). The axle housing 32 may enclose at least part, if not most, of the axle shaft 30. The hub 34 may be coupled to an end 38 of the axle housing 32, by a plurality of fasteners, such as, bolts 40. However, the hub 34 may be secured to the axle housing 32 in other ways.

The planetary gear set 36 may be mounted to an end 42 of the axle shaft 30 and may comprise a sun gear 44, a plurality of planet gears 46, a ring gear 48, and a single-piece integrated wheel and planet carrier 50. The sun gear 44 may be coupled to the axle shaft 30. For example, on one side, the sun gear 44 may include a sleeve 52 configured to receive the end 42 of the axle shaft 30. In so doing, a reduced size of the sun gear 44 may be used. However, the sun gear 44 may be coupled to the axle shaft 30 in other ways. For instance, the sun gear 44 may be splined around a circumference of the axle shaft 30, or the sun gear 44 may be integral to the axle shaft 30.

Each of the plurality of planet gears 46 may be in meshing contact with the sun gear 44 and the ring gear 48. The ring gear 48 may be rigidly fixed to the hub 34. For example, the ring gear 48 may be splined to the hub 34, although other types of attachment may be used. In another example, the ring gear 48 may be integral to the hub 34. The plurality of planet gears 46 may be rotatably mounted to the single-piece integrated wheel and planet carrier 50, which may connect the plurality of planet gears 46 and serve as the wheel of the wheel assembly 24. In so doing, the planet carrier 50 may simultaneously be an output of the planetary gear set and the wheel of the wheel assembly 24.

The rim 28 may be coupled to the planet carrier 50, by a plurality of fasteners, such as, bolts 54. In order to facilitate attachment to the rim 28, the planet carrier 50 may include a flange 56 with a plurality of bores 58 arranged around a circumference of the flange 56. The plurality of bores 58 may be configured to receive the plurality of bolts 54. However, other configurations and types of attachment between the rim 28 and the planet carrier 50 may be used. The rim 28 may be configured to mount the tire 26 onto the integrated wheel and planet carrier 50.

A first bearing set 60 and a second bearing set 62 may rotatably mount the planet carrier 50 to the hub 34. More specifically, the hub 34 may be generally cylindrical in shape, enclosing at least part of the axle shaft 30, at least part of a brake mechanism 64, and at least part of the planetary gear set 36. For example, the hub 34 may enclose a plurality of brake discs 66 splined around the axle shaft 30, a plurality of reaction plates 68 interspersed between the plurality of brake discs 66, and a brake reaction plate 96.

The hub 34 may also enclose the sun gear 44, the plurality of planet gears 46, the ring gear 48, and at least part of the planet carrier 50. The flange 56 of the planet carrier 50 may be disposed outside of the hub 34 for attachment of the planet carrier 50 to the rim 28. A seal plate 70 may be attached to an end 72 of the hub 34, and a cover plate 98 may be attached to an end 100 of the planet carrier 50. Each of the seal plate 70 and the cover plate 98 may seal oil or other lubricants within the wheel assembly 24.

For example, a plurality of fasteners, such as, bolts 112, may couple the seal plate 70 to the hub 34 and the cover plate 98 to the planet carrier 50. However, the seal plate 70 and the cover plate 98 may be secured in other ways. Furthermore, instead of being separate pieces from the hub 34 and the planet carrier 50, the seal plate 70 and/or the cover plate 98 may also be integral to the hub 34 and the planet carrier 50, respectively.

It is to be understood that other arrangements for the hub 34 than that described and shown, in FIGS. 2-4, may be used. The hub 34 may be a stationary structure through which a reaction torque of the integrated wheel and planet carrier 50 may be transferred to the axle housing 32. In so doing, the hub 34 may take a place of a spindle, thereby eliminating a cost, weight, and space of the spindle.

The first bearing set 60 and the second bearing set 62 may be axially spaced apart from each other. Furthermore, the first bearing set 60 and the second bearing set 62 may be tapered in order to accommodate a shape of the planet carrier 50 within the hub 34. For example, a diameter D₂ of the second bearing set 62 may be larger than a diameter D₁ of the first bearing set 60. The planet carrier 50 may be disposed radially inward of each of the first bearing set 60 and the second bearing set 62, while the hub 34 may be disposed radially outward of each of the first bearing set 60 and the second bearing set 62.

More specifically, the first bearing set 60 and the second bearing set 62 may be press fit radially between the hub 34 and the planet carrier 50. However, the first bearing set 60 and the second bearing set may be secured in other ways Inner races 74, 76 of the first bearing set 60 and the second bearing set 62, respectively, may be pressed onto the planet carrier 50, while outer races 78, 80 of the first bearing set 60 and the second bearing set 62, respectively, may interface with the hub 34. Rollers 82, 84 of the first bearing set 60 and the second bearing set 62, respectively, may be disposed between the inner races 74, 76 and the outer races 78, 80. In so doing, the first bearing set 60 and the second bearing set 62 allow rotation of the planet carrier 50 within the stationary hub 34.

In addition, the first bearing set 60 may be retained axially between a bearing retainer 102 on one side and the hub 34 and the planet carrier 50 on the other side. For instance, the first bearing set 60 may be press fit between the bearing retainer 102 and surfaces 104, 106 of the hub 34 and the planet carrier 50, respectively. The second bearing set 62 may be retained axially between the hub 34 and the planet carrier 50. More specifically, the second bearing set 62 may be press fit between a surface 108 of the hub 34 and a surface 110 of the planet carrier. However, the first bearing set 60 and the second bearing set 62 may be secured in other ways.

Furthermore, a centerline 86 of the tire 26 (FIG. 1) may be centrally aligned between the first bearing set 60 and the second bearing set 62. A weight and/or load of the machine 20 may thereby be transferred through the first bearing set 60 and the second bearing set 62 in balanced fashion. In addition, the plurality of planet gears 46 and the ring gear 48 may be disposed between the first bearing set 60 and the second bearing set 62. More specifically, the plurality of planet gears 46 and the ring gear 48 may be centrally aligned between the first bearing set 60 and the second bearing set 62, along with the centerline 86 of the tire 26. In so doing, the load on the machine 20 may be balanced and centered through the planetary gear set 36. Thus, the central alignment of the tire 26, the plurality of planet gears 46, and the ring gear 48 between the first bearing set 60 and the second bearing set 62 provides a uniform, vertical loading on the wheel assembly 24 and eliminates cantilever effects. In so doing, the operation and longevity of the wheel assembly is improved.

### INDUSTRIAL APPLICABILITY

In general, the foregoing disclosure finds utility in various industrial applications, such as, in earthmoving, construction, industrial, agricultural, mining, transportation, and forestry machines. In particular, the disclosed mechanism may be applied to earth-moving vehicles, loaders, dozers, motor graders, tractors, backhoes, excavators, trucks, mining vehicles, on-highway vehicles, trains, agricultural equipment, material handling equipment, and the like.

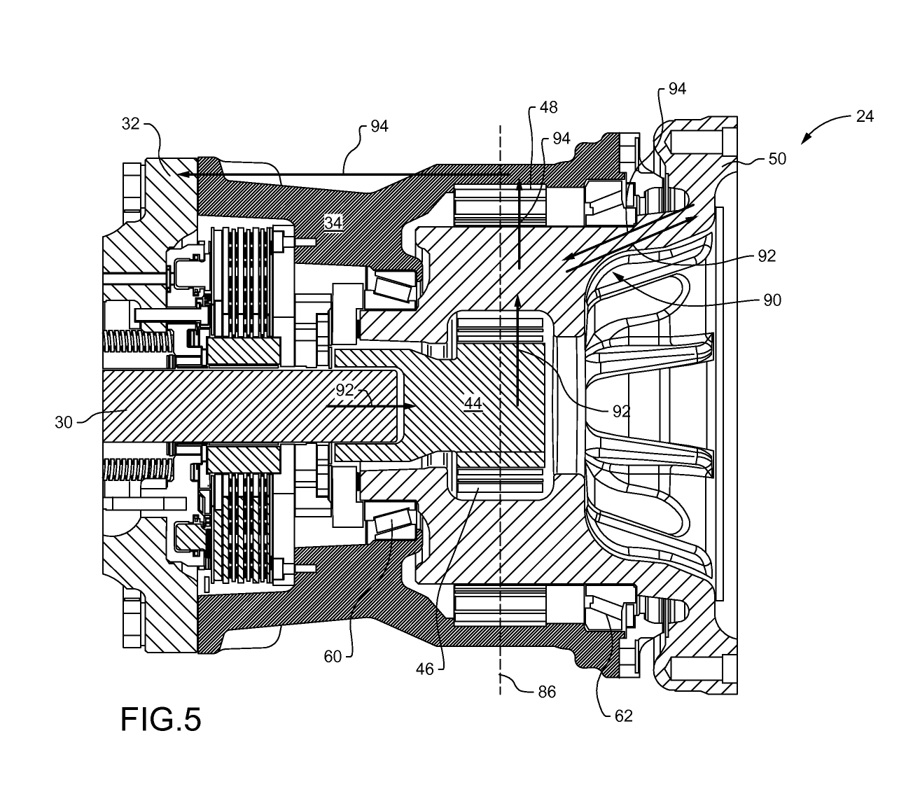

Turning now to FIG. 5, with continued reference to FIGS. 1-4, a diagram illustrating power flow 90 through the wheel assembly 24 during operation is shown, in accordance with an embodiment of the present disclosure. As shown by arrows 92, power may flow through the axle shaft 30 to the sun gear 44 to the plurality of planet gears 46 and to the integrated wheel and planet carrier 50, which is the output. The axle shaft 30, the sun gear 44, the plurality of planet gears 46, and the planet carrier 50 may comprise the moving parts of the wheel assembly 24 during operation of the machine 20. As shown by arrows 94, reaction torque from the integrated wheel and planet carrier 50 may be transferred back through the plurality of planet gears 46 to the ring gear 48 through the hub 34 and to the axle housing 32. The ring gear 48, the hub 34, and the axle housing 32 may comprise the stationary parts of the wheel assembly 24 during operation of the machine 20.

The path of the reaction torque, represented by arrows 94, through the wheel assembly 24 to the axle housing 32 is short and direct, thereby causing low stress on the components of the wheel assembly 24. Moreover, since the planet gears 46 and the ring gear 48 are centered between the first bearing set 60 and the second bearing set 62, the power flow and reaction torque through the planetary gear set 36 are also centrally aligned with the load on the machine 20. As a result, the forces on the machine 20 during operation are balanced, thereby leading to significantly reduced wear and tear on the bearing sets 60, 62, planetary gear set 36 and hub 34, longer life for the bearing and planetary gear sets, as well as an overall increased efficiency of the wheel assembly 24.

In addition, the present disclosure provides a compact wheel assembly with a hub that eliminates the need for an expensive spindle and enables a shorter axle shaft length, compared to prior art wheel designs. Furthermore, the disclosed wheel assembly integrates the wheel and the planet carrier into a single piece, thereby further reducing the number of parts in the assembly. This results in significantly reduced weight and space requirements for the disclosed wheel assembly. By decreasing the number of parts, the size, and the weight of the wheel assembly, the cost of the wheel assembly also significantly decreases. Therefore, not only does the disclosed wheel assembly provide a balanced and robust wheel design, but also a cost-effective one.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto. Moreover, while some features are described in conjunction with certain specific embodiments, these features are not limited to use with only the embodiment with which they are described, but instead may be used together with or separate from, other features disclosed in conjunction with alternate embodiments.

What is claimed is:

1. A wheel assembly for a machine, comprising:
a hub coupled to an axle housing; and
a planetary gear set including a single-piece integrated wheel and planet carrier, the single-piece integrated wheel and planet carrier serving as a wheel of the machine, the single-piece integrated wheel and planet carrier rotatably mounted within the hub by a first bearing set and a second bearing set axially spaced apart from the first bearing set.

2. The wheel assembly of claim 1, wherein the planetary gear set further includes a plurality of planet gears rotatably mounted on the planet carrier, the plurality of planet gears positioned between the first bearing set and the second bearing set.

3. The wheel assembly of claim 2, wherein the planetary gear set further includes a ring gear splined to the hub.

4. The wheel assembly of claim 3, wherein the ring gear is positioned between the first bearing set and the second bearing set, the ring gear in meshing contact with the plurality of planet gears.

5. The wheel assembly of claim 4, wherein the ring gear and the plurality of planet gears are centrally aligned between the first bearing set and the second bearing set.

6. The wheel assembly of claim 5, wherein a centerline of a tire of the machine is centrally aligned between the first bearing set and the second bearing set.

7. The wheel assembly of claim 6, wherein the central alignment of the ring gear, the plurality of planet gears, and the tire between the first bearing set and the second bearing set balances a load of the machine.

8. The wheel assembly of claim 7, wherein a rim of the tire is coupled to the single-piece integrated wheel and planet carrier.

9. The wheel assembly of claim 8, wherein a diameter of the second bearing set is larger than a diameter of the first bearing set.

10. The wheel assembly of claim 9, wherein the hub has a generally cylindrical shape that encloses at least part of the planetary gear set, at least part of an axle shaft, and at least part of a brake mechanism of the machine.

11. A machine, comprising:
a power source;
an axle shaft operatively coupled to the power source;
an axle housing enclosing at least part of the axle shaft;
a hub coupled to the axle housing;
a planetary gear set operatively mounted to the axle shaft, the planetary gear set including:
a ring gear rigidly fixed to the hub,
a plurality of planet gears in meshing contact with the ring gear, and
a planet carrier operatively connecting the plurality of planet gears, the planet carrier serving as a wheel;
a first bearing set; and
a second bearing set axially spaced apart from the first bearing set, each of the first bearing set and the second bearing set rotatably mounting the planet carrier within the hub.

12. The machine of claim 11, further comprising a rim of a tire coupled to the planet carrier.

13. The machine of claim 12, wherein the plurality of planet gears and a centerline of the tire are centrally aligned between the first bearing set and the second bearing set.

14. The machine of claim 13, wherein the ring gear is splined into the hub.

15. The machine of claim 14, wherein the planet carrier is disposed radially inward of each of the first bearing set and the second bearing set.

16. The machine of claim 15, wherein the hub is disposed radially outward of each of the first bearing set and the second bearing set.

17. The machine of claim 16, wherein the hub takes a place of a spindle.

18. A wheel assembly for a machine, comprising:
a first bearing set;
a second bearing set spaced apart from the first bearing set; and
a plurality of planet gears centered between the first bearing set and the second bearing set in order to balance a load of the machine.

19. The wheel assembly of claim 18, wherein the first bearing set and the second bearing set rotatably mount a single-piece integrated wheel and planet carrier to a hub, the single-piece integrated wheel and planet carrier operatively connecting the plurality of planet gears.

20. The wheel assembly of claim 19, further comprising a ring gear splined to the hub, the ring gear in meshing contact with the plurality of planet gears.
